(19) United States
(12) Patent Application Publication
(10) Pub. No.: US 2024/0399306 A1
(43) Pub. Date: Dec. 5, 2024

(54) ATTRITIVE CARBON DIOXIDE CAPTURE AS FRIABLE MAGNESIUM CARBONATE PARTICULATES

(71) Applicant: NEGATIVE EMISSIONS MATERIALS, INC., New Castle, DE (US)

(72) Inventor: David DREISINGER, Delta (CA)

(21) Appl. No.: 18/697,110

(22) PCT Filed: Sep. 29, 2022
(86) PCT No.: PCT/IB2022/059312

§ 371 Date: Mar. 29, 2024

Related U.S. Application Data
(60) Provisional application No. 63/251,335, filed on Oct. 1, 2021.

(51) Int. Cl. B01D 53/81; B01D 53/62; B01D 53/96; C01F 5/24

(52) U.S. Cl. CPC B01D 53/81; B01D 53/62; B01D 53/96; C01F 5/24; B01D 2251/402; B01D 2251/602; B01D 2251/604; B01D 2257/504; B01D 2258/06

(57) ABSTRACT

The invention provides processes for capture of gaseous carbon dioxide in the form of magnesium carbonates, with attrition of friable surface passivation layers on magnesium oxide/magnesium hydroxide particulates to facilitate more complete carbonation of reactive carbon capture particulates.

### FIELD

The invention is in the field of inorganic chemistry, providing processes for capture and sequestration of carbon dioxide as magnesium carbonates.

### BACKGROUND

Technologies for efficient sequestration of gaseous carbon dioxide are potentially an important tool for addressing anthropogenic climate change. A wide range of techniques have been proposed for capturing carbon dioxide in the form of solid calcium carbonate (CaCO₃), or other metal carbonates. Various chemical looping systems have for example been proposed that involve calcining of CaCO₃ to produce lime (CaO) and a concentrated stream of CO₂, with the collected CO₂ then amenable to post-processing, for example by compression and sequestration.

It has been suggested that magnesium chemistries offer advantages over calcium chemistries for some forms of looping CO₂ sequestration processes (see McQueen, N., Kelemen, P., Dipple, G. et al. Ambient weathering of magnesium oxide for CO₂ removal from air. Nat Commun 11, 3299 (2020)). In particular, the calcining temperatures for magnesite (MgCO₃) are lower than for CaCO₃. As such, magnesia (MgO) or Brucite (Mg(OH)₂) offer advantages over lime for CO₂ capture, in a system in which the corresponding carbonate is calcined to regenerate the metal oxide for further rounds of CO₂ uptake.

Challenges remain in the use of MgO for CO₂ capture related to the relatively low capacity of even very porous MgO to react with CO₂ (see McQueen et al., op cit). To date, efforts to ameliorate this problem have focused on optimizing the porosity of MgO particulates, for example by modulating the conditions under which MgCO₃ is calcined to provide the MgO reactant (see Song, G., Ding, Y. D., Zhu, X. & Liao, Q. Carbon dioxide adsorption characteristics of synthesized MgO with various porous structures achieved by varying calcination temperature. Colloids Surf. A Physicochem. Eng. Asp. 470, 39-45 (2015)).

### SUMMARY

As disclosed herein, in the course of CO₂ capture, magnesium carbonate forms a friable surface passivation layer on MgO/Mg(OH)₂ particles, limiting the ability of these particles to capture additional CO₂. Whereas the magnesium carbonate is relatively friable, and thereby amenable to attrition, the underlying MgO/Mg(OH)₂ particles are recalcitrant to attrition. Processes are accordingly provided for attrition of surface magnesium carbonate from MgO/Mg(OH)₂ particulates, in conjunction with ongoing gaseous CO₂ capture by the attrited and thereby delaminated solid MgO/Mg(OH)₂ particulates.

### BRIEF DESCRIPTION OF THE DRAWINGS

FIG. 1 is a schematic illustration of an attritive CO₂ capture process, with carbon capture steps interspersed with steps of attrition, leading to calcination of MgCO₃ to regenerate MgO for carbon capture.

### DETAILED DESCRIPTION

Processes are provided for the batch, continuous or semi-continuous removal of a MgCO₃ product layer from MgO and/or Mg(OH)₂ particles (referred to herein as “MgO/Mg(OH)₂” particulates) in the course of CO₂ capture by the particles. For example, a continuous process may involve light attrition grinding of the partially reacted MgO/Mg(OH)₂ material to remove at least some of the MgCO₃ product layer and expose fresh MgO or Mg(OH)₂ for further reaction with CO₂. Attrition grinding can be performed, for example, in one or more of an IsaMill, a HIG Mill, a Jet Mill, a ball mill or a rod mill. Cyclonic agitation may for example be used to provide attritive forces to separate surface MgCO₃ from underlying MgO/Mg(OH)₂ particles, while simultaneously segregating MgCO₃ fines from the delaminated MgO/Mg(OH)₂ particles. Abrasives may be added to the attrition step, to facilitate abrasive delamination of MgCO₃ from MgO/Mg(OH)₂ particles.

As disclosed herein, MgO/Mg(OH)₂ particulates may be used to sequester CO₂ by forming MgCO₃ by reaction with carbon dioxide from air, combustion gases or artificially enriched gas streams containing carbon dioxide. The simplified reactions include:

MgO+CO₂(g)→MgCO₃

MgO+H₂O→Mg(OH)₂

Mg(OH)₂+CO₂(g)→MgCO₃+H₂O

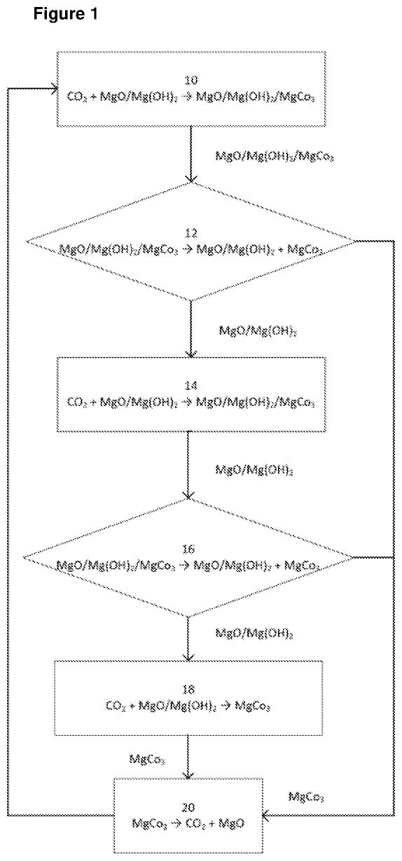

As illustrated in FIG. 1, carbon capture steps 10, 14 and 18 are linked to attrition steps 12 and 16, with carbon capture steps 10, 14 yielding laminated composite MgO/Mg(OH)₂/MgCO₃ particles, in which a MgCO₃ surface layer passivates further carbon capture by underlying MgO/Mg(OH)₂. Attrition steps 12, 16 delaminate the composite MgO/Mg(OH)₂/MgCO₃ particles, releasing a MgCO₃ product. The MgCO₃ product may then be directed to calcining step 20, which in turn yields regenerated MgO for recirculation to carbon capture step 10. The iterative, continuous or semi-continuous process proceeds to optimize utilization of the MgO/Mg(OH)₂ carbon capture material, schematically illustrated by a final carbon capture step 18 in which the yield is MgO₃.

In select embodiments, a CO₂ stream is introduced into the grinding apparatus. In this way, carbonation and surface attritioning can proceed simultaneously, continuously facilitating high efficiency carbonation.

In a semi-continuous system, processes involve separate discrete steps of contacting the MgO/Mg(OH)₂ solid with a CO₂ containing gas stream, with separate steps of carbonated particle attritioning to delaminate a MgCO₃ surface layer from the carbonated particles.

Temperature may be adjusted to modulate the kinetics of particulate carbonation. In general, increasing temperatures will increase the rate of carbonation up to a temperature at which the magnesium carbonate becomes labile.

Initial MgO/Mg(OH)₂ particle size may similarly be adjusted to modulate rates of carbonation and/or attrition. The initial surface area of the MgO/Mg(OH)₂ particles may also be controlled, for example by calcining under specific conditions. The reactivity of MgO/Mg(OH)₂ particles may for example be enhanced by decreasing particle size. The porosity of particles may be adjusted to optimize both chemical carbonation and physical delamination processes.

The pressure and concentration of carbon dioxide in the reactive gas may be adjusted to modulate rates of carbonation. The reactive gas may for example have a CO₂ content of from ˜400 ppm CO₂ (e.g. ambient air) up to a pure 100% CO₂ reactive gas stream.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Terms such as “exemplary” or “exemplified” are used herein to mean “serving as an example, instance, or illustration.” Any implementation described herein as “exemplary” or “exemplified” is accordingly not to be construed as necessarily preferred or advantageous over other implementations, all such implementations being independent embodiments. Unless otherwise stated, numeric ranges are inclusive of the numbers defining the range, and numbers are necessarily approximations to the given decimal. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification, and all documents cited in such documents and publications, are hereby incorporated herein by reference as if each individual publication were specifically and individually indicated to be incorporated by reference herein and as though fully set forth herein. The invention includes all embodiments and variations substantially as hereinbefore described and with reference to the examples and drawings.

1. A process for fixation of carbon dioxide, comprising: reacting a gaseous carbon dioxide (CO_{2(g)}) feedstock with a solid particulate reactant comprising magnesium oxide (MgO) and/or magnesium hydroxide (Mg(OH)₂), to form composite MgO/Mg(OH)₂ particles laminated with a surface layer of magnesium carbonate (MgCO₃); attriting the composite MgO/Mg(OH)₂/MgCO₃ particles to delaminate surface MgCO₃ from the composite MgO/Mg(OH)₂/MgCO₃ particles, to yield delaminated MgO/Mg(OH)₂ particles and a MgCO₃ product; and, reacting the CO₂ (g) feedstock with the delaminated MgO/Mg(OH)₂ particles to form an additional MgCO₃ product.

2. The process of claim 1, further comprising calcining the MgCO₃ product and the additional MgCO₃ product.

3. The process of claim 1, wherein the process is continuous.

4. The process of claim 1, wherein reacting and attriting steps are carried out simultaneously in an attriting carbon capture reactor.
